(19) United States
(12) Patent Application Publication
(10) Pub. No.: US 2025/0251043 A1
(43) Pub. Date: Aug. 7, 2025

(54) BUTTERFLY VALVE

(71) Applicant: ASC Engineered Solutions, LLC, Portsmouth, NH (US)

(72) Inventors: Matthew William McNamara, Portsmouth, NH (US); Amir Nemenoff, Karkom (IL)

(21) Appl. No.: 18/435,199

(22) Filed: Feb. 7, 2024

(51) Int. Cl. F16K 1/22; F16K 1/226; F16K 27/02

(52) U.S. Cl. CPC F16K 1/222; F16K 1/2263; F16K 27/0218

(57) ABSTRACT

A disc valve comprising a valve-body assembly is described. The valve-body assembly comprises a valve body, a seat ring within the valve body, an endcap coupled to the valve body and at least partially surrounding the seat ring, and a disc. The disc comprises an arcuate convex first surface, and an arcuate concave second surface. The first surface is opposite the second surface.

### TECHNICAL FIELD

This disclosure relates to valves. More specifically, this disclosure relates to improved designs of butterfly valves.

### BACKGROUND

Butterfly valves rotate a disc from an open configuration to a closed configuration to seal a fluid channel through the valve. In the open configuration, the valve creates friction with the working fluid, which is often measured in a pressure drop measured in “head,” e.g., in pounds per square inch (psi). An ideal valve produces infinite friction in the closed configuration (e.g., seals the flow channel) and zero friction in the open configuration. The amount of friction through the flow channel is sometimes quantified by a dimensionless number that describes the fluid properties of the friction in valve, for example, in the open configuration.

### SUMMARY

It is to be understood that this summary is not an extensive overview of the disclosure. This summary is exemplary and not restrictive, and it is intended to neither identify key or critical elements of the disclosure nor delineate the scope thereof. The sole purpose of this summary is to explain and exemplify certain concepts of the disclosure as an introduction to the following complete and extensive detailed description.

In one aspect, disclosed is a disc valve comprising a valve body and a disc positioned in the valve body, the disc rotatable within the valve body to define an open configuration and a closed configuration. The disc comprises an arcuate convex first surface and an arcuate concave second surface. The first surface is opposed to the second surface.

In a further aspect, disclosed is a disc valve comprising a valve body, an endcap coupled to the valve body, and a seat ring. A rib is captured between the valve body and the endcap. A valve body shoulder extends from the rib towards the valve body, and an endcap shoulder extends from the rib towards the endcap. A valve body angled portion extends from the valve body shoulder. An endcap angled portion extends from the endcap shoulder. A sealing lip is defined at the intersection of the valve body angled portion and the endcap angled portion.

Various implementations described in the present disclosure may comprise additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims. The features and advantages of such implementations may be realized and obtained by means of the systems, methods, features particularly pointed out in the appended claims. These and other features will become more fully apparent from the following description and appended claims or may be learned by the practice of such exemplary implementations as set forth hereinafter.

### BRIEF DESCRIPTION OF THE DRAWINGS

The accompanying drawings, which are incorporated in and constitute a part of this specification, illustrate several aspects of the disclosure and, together with the description, serve to explain various principles of the disclosure. The drawings are not necessarily drawn to scale. Corresponding features and components throughout the figures may be designated by matching reference characters for the sake of consistency and clarity.

FIG. 1 is a perspective view of a butterfly valve with the disc in an open configuration in accordance with one aspect of the current disclosure.

FIG. 2 is a front view of the butterfly valve of FIG. 1 with the disc in an open configuration.

FIG. 3 is a front view of the butterfly valve of FIG. 1 with the disc in a closed configuration.

FIG. 4 is an exploded side view of the valve-body assembly.

FIG. 5 is a partial cross-section of the valve-body assembly showing a detailed view of the seat ring taken along line 5-5 of FIG. 1.

FIG. 6 is a perspective view of the arcuate back surface of the disc.

FIG. 7 is a perspective view of the arcuate front surface of the disc.

FIG. 8 is a cross-sectional view of the disc taken along line 8-8 of FIG. 6.

FIG. 9 is a cross-sectional view of detail 10 showing the seat ring in isolation.

FIG. 10 is an enlarged view of detail 10 of the seat ring shown in FIG. 5.

FIG. 11 is a cross-sectional view of the valve taken along line 5-5 of FIG. 3, with the valve operating with the disc in a partially open configuration.

FIG. 12 is a cross-sectional view of the valve taken along line 5-5 of FIG. 3, with the valve operating with the disc in a nearly closed configuration.

FIG. 13 is a cross-sectional view taken along line 5-5 of FIG. 3, with a flat disc in the open configuration schematically illustrating the fluid dynamics of flow with the flat disc.

FIG. 14 is a cross-sectional view taken along line 5-5 of FIG. 3, with an arcuate-shaped disc in the open configuration, schematically illustrating the fluid dynamics of flow with the arcuate-shaped disc.

FIG. 15 is a front-view schematic illustrating the fluid dynamics of a flow through a butterfly valve with a flat disc.

FIG. 16 is a front-view schematic illustrating the fluid dynamics of flow through a butterfly valve with an arcuate shaped disc.

FIG. 17 is a schematic flow diagram illustrating the improved flow capacity C_{V} that results from using an arcuate disc at various orientations within a 4-inch valve.

### DETAILED DESCRIPTION

The present disclosure can be understood more readily by reference to the following detailed description, examples, drawings, and claims, and their previous and following description. However, before the present devices, systems, and/or methods are disclosed and described, it is to be understood that this disclosure is not limited to the specific devices, systems, and/or methods disclosed unless otherwise specified, as such can, of course, vary. It is also to be understood that the terminology used herein is for the purpose of describing particular aspects only and is not intended to be limiting.

In one aspect, a butterfly valve comprising a disc with two opposed arcuate surfaces and associated methods, systems, devices, and various apparatuses as disclosed herein. In one aspect, the butterfly valve can comprise an arcuate front surface that is concave and a convex arcuate back surface opposite the arcuate front surface.

The convex surface restricts the flow at the centerline of the surface and accelerates the working fluid through the valve at the centerline defined by the butterfly valve. Since the cross-sectional area through this side is reduced, fluid is accelerated, and the pressure is reduced on this side of the butterfly valve. Conversely, on the opposite side, the concave surface increases the cross-sectional area and reduces the fluid velocity, and increases the pressure. These two effects offset one another and result in an overall system where the pressure drop and velocity through the valve are enhanced. This can create a pressure/velocity differential across the valve (e.g., across the disc) that facilitates the movement of the fluid through the valve. That is, by creating two opposed surfaces that generate opposite fluid-dynamic effects in each of the two opposed channels, the overall effect is balanced and created by the butterfly valve, and enhances the flow coefficient through the valve.

A seal ring can comprise a rib that is captured between a valve body and an endcap and further comprises a sealing lip that interacts with the disc to create a seal, e.g., when the valve disc is in the closed configuration. Capturing the seal ring between the valve body and the endcap facilitates a low-friction seal that resists “freezing” or locking the rotation of the valve in an open or closed configuration. In addition, the lower torque to open and close the valve can facilitate the operation of the valve with an actuator. Angled portions and shoulders extending from the rib to the sealing lip of the seal ring can direct flow to generate hydrostatic gaps in the seal that compress the seal ring and ensure the seat is properly sealed. A seal ring comprising opposing angled surfaces can control the hydrostatic loads that cause the gaps and result in a more efficient seal.

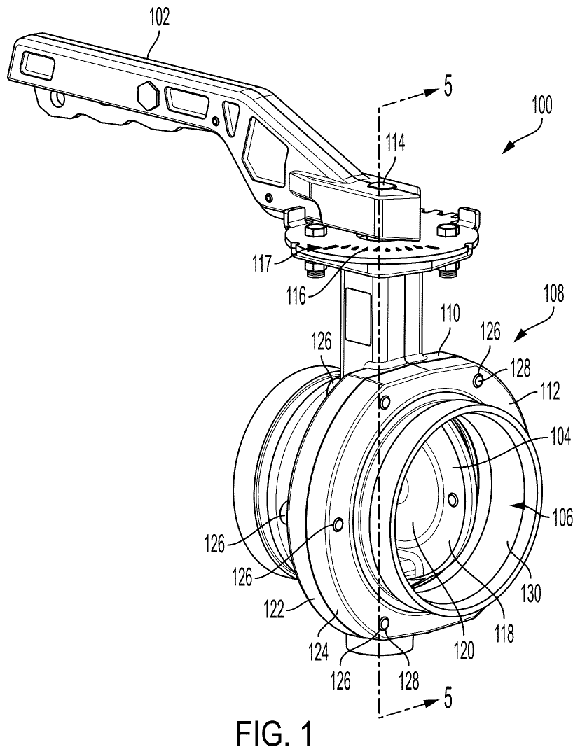

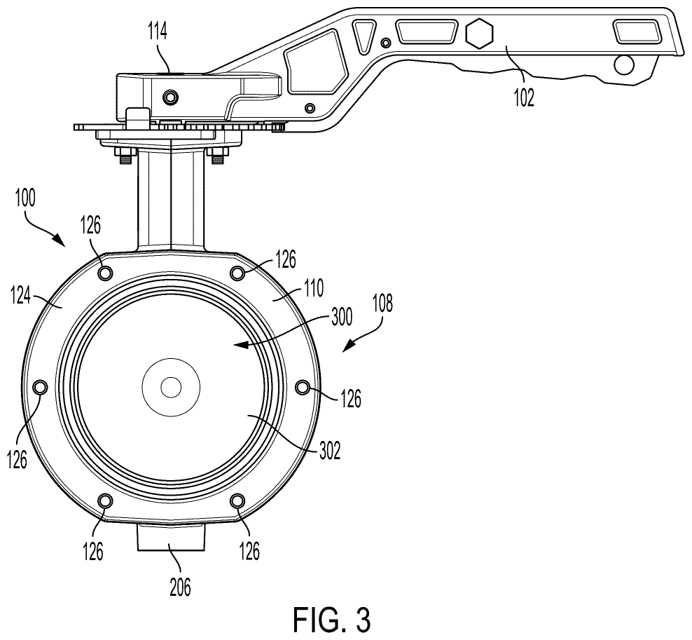

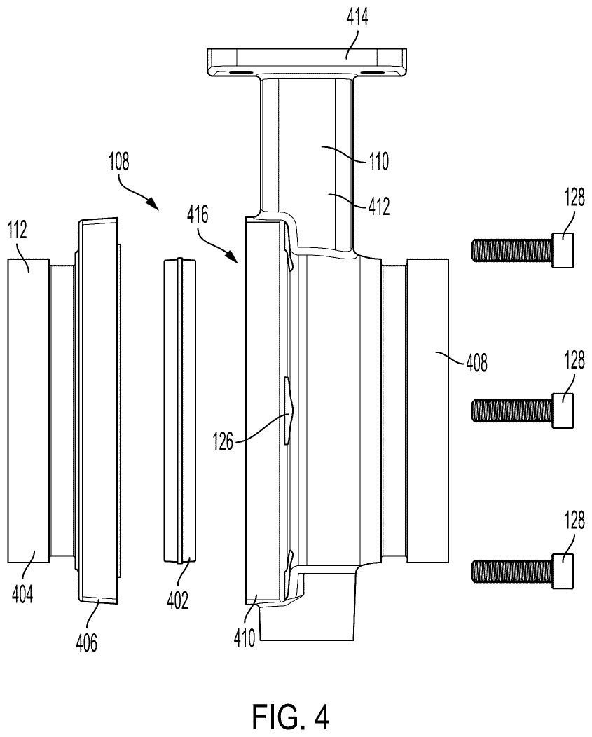

FIG. 1 shows a butterfly valve 100 comprising a handle 102 operatively engaged with and configured to rotate a disc 104, which is shown in an open configuration 106. The disc 104 can be captured within a valve-body assembly 108 comprising a valve body 110 and an endcap 112 coupled to valve body 110. A stem 114 can extend through the valve body 110 and couple handle 102 to disc 104. When handle 102 is rotated from the open configuration 106 to a closed configuration 300 (FIG. 3) various indicia 116 can indicate the angle of disc 104 relative to the open configuration 106 and/or closed configuration 300. The indicia 116 can be defined on an indicia plate 117 mounted on a handle attachment portion 414 (FIG. 4) of the valve body 110.

Disc 104 can be an arcuate disc, such that one or more surfaces of disc 104 can define a curvilinear shape. Specifically, as shown in FIG. 1, disc 104 defines a flat base section 118 that circumferentially surrounds an arcuate back surface 120 of the disc 104. An arcuate front surface 302 (FIG. 3) can complement arcuate back surface 120 of disc 104 and together improve flow dynamics through valve 100 and enhance the flow capacity coefficient Cᵥ.

Valve body 110 is shown with the endcap 112 comprising an endcap flange 122. Valve body 110 can comprise a valve flange 124, such that the valve body 110 and the endcap 112 each comprise a flange (e.g., flanges 122 and 124) for a bolted construction to securely couple and seal endcap 112 to valve body 110. As shown, bolts or fasteners 126 extend through fastener holes 128 to couple the valve flange 124 of the valve body 110 to the endcap flange 122 of the endcap 112. Fasteners 126 can extend through threaded holes 128 and/or bolds can utilize nuts to secure the endcap flange 122 to the valve flange 124. In some aspects, valve-body assembly 108 can comprise a sidewall 130 that extends through valve body 110 and/or endcap 112.

As used herein, the flow capacity coefficient Cᵥ is a dimensionless number defined as the number of U.S. gallons per minute of water at 60° F., which pass through the device with a pressure drop of 1 psi. In general, the device can be the butterfly valve 100 with arcuate disc 104, however, the flow coefficient is a type of capacity index that can be used to compare the efficiencies of a variety of devices and/or valves and provides a mechanism to compare the results of the arcuate disc 104 relative to a flat surface butterfly valve design.

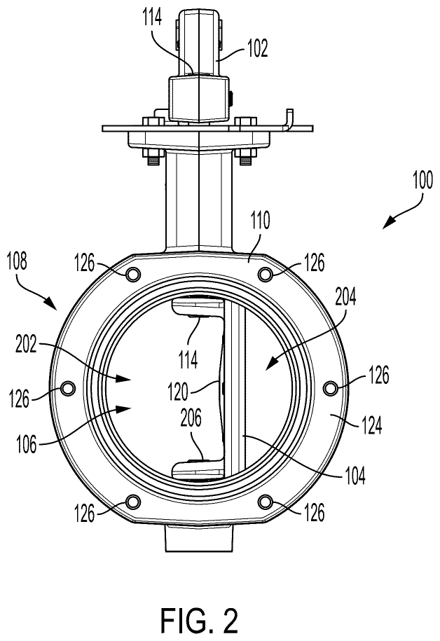

FIG. 2 shows butterfly valve 100 with disc 104 in the open configuration 106, and FIG. 3 shows disc 104 rotated 90 degrees (π/2 radians) into the closed configuration 300. The endcap flange 122 attaches or couples to the valve flange 124 with fasteners 126 extending through multiple fastener holes 128 so that in some aspects, the valve can be assembled/disassembled and/or serviced with available hand tools.

Disc 104 can comprise the arcuate back surface 120 and/or the arcuate front surface 302. The arcuate back surface 120 can be convex and reduce a front cross-sectional area 202 of the working fluid on the first side (e.g., arcuate back surface 120) of disc 104. In various aspects, the fluid can be any working fluid, such as a liquid or gas. For example, the fluid can be a compressible and/or an incompressible fluid. Example fluids include, water, oil, petroleum, gasoline, and/or gasses. Similarly, the front surface can comprise arcuate front surface 302 (FIG. 3), which is concave to increase a rear cross-sectional area 204 of the working fluid on the second side (e.g., arcuate front surface 302 in FIG. 3) of disc 104 opposite the first side (e.g., arcuate back surface 120). As used herein, the front cross-sectional area 202 is defined between the arcuate back surface 120 and the valve body 110. Similarly, the rear cross-sectional area 204 is defined between the arcuate front surface 302 (FIG. 3) and the valve body 110.

In various aspects, a stub 206 couples disc 104 to valve body 110 at a location opposite from stem 114 to support disc 104 in the open configuration 106, as shown in FIGS. 1 and 2. In the closed configuration 300, the opposed stem 114 and stub 206 support disc 104 to facilitate and enable the force generated on disc 104 under increased pressure.

FIG. 4 shows an exploded view of valve-body assembly 108 comprising endcap 112, valve body 110, a seat ring 402, and a plurality of fasteners 126. Endcap 112 comprises a pipe coupling portion 404 and a flange portion 406. Similarly, valve body 110 comprises a pipe coupling portion 408, a flange portion 410, a neck portion 412, and handle attachment portion 414 supporting indica plate 117 (FIG. 1). Fasteners 126 are configured to extend through fastener holes 128 and couple the endcap 112 to the valve body 110. In various aspects, fastener holes 128 can be threaded such that the fasteners 126 are threaded into the fastener holes 128 to seal valve body 110 to endcap 112. Nuts, bolts, and/or other fittings can also be used to couple the valve body 110 to the endcap 112. A seat 416 for the disc 302 is formed in valve-body assembly 108 when valve body 110 compresses a seal against endcap 112 to create a seat for disc 302.

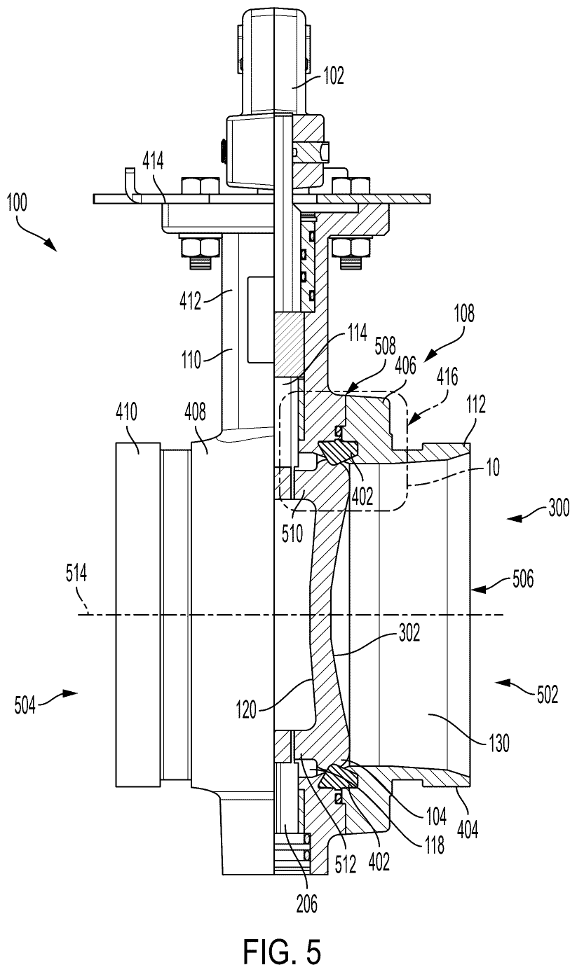

FIG. 5 is a partial cross-section of valve body 110 showing detail 10 of the valve-body assembly 108 capturing and encasing the seat ring 402. In some aspects, stem 114 couples handle 102 to arcuate disc 104. The arcuate back surface 120 can be convex and is shown in the closed configuration 300. Arcuate front surface 302 can be concave, as shown in the closed configuration 300 of FIG. 5. The closed configuration 300 prevents fluid (e.g., water, oil, natural gas, petroleum, sewage, storm water, and/or other fluid) from entering an upstream inlet 502 from exiting the downstream outlet 504. That is, in the closed configuration 300, fluid is prevented from flowing through valve channel 506 due to a fluid-tight seal formed at seat 416. In some aspects, butterfly valve 100 can be bi-directional, and the inlet 502 can be defined as the side of the valve body 110 that has the higher pressure, and the outlet 504 can be defined as the side of the valve body 100 that has the lower pressure in the closed configuration 300.

Seat 416 can be formed between arcuate disc 104 compressed against seat ring 402. Seat ring 402 can be captured and/or encapsulated between a joint 508 formed between and defined by the coupling of endcap 112 and valve body 110. In the closed configuration 300, a sealing seat 416 can be formed as the disc 104 of butterfly valve 100 compresses against the seat ring 402 to form a fluid-tight seal.

As shown in FIG. 5, arcuate disc 104 can comprise an upper ear 510 and a lower ear 512, such that stem 114 does not extend across the arcuate back surface 120 of disc 104. That is, stem 114 couples to upper ear 510, and stub 206 is coupled to lower ear 512.

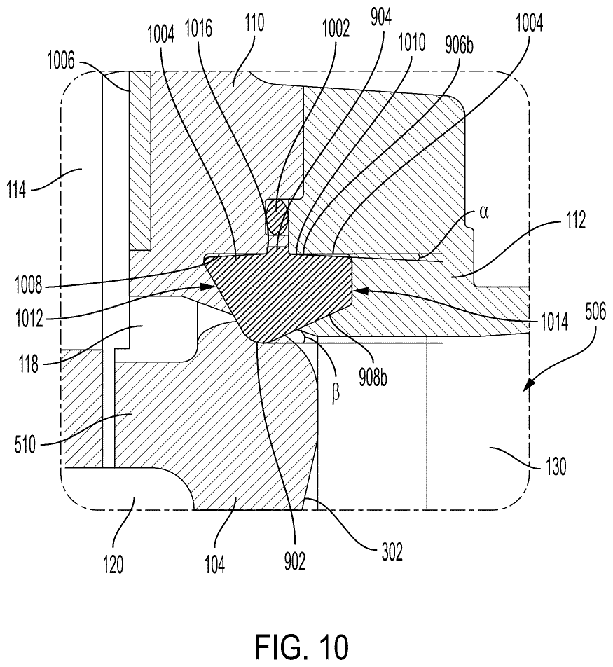

The seat ring 402 comprises a cross-sectional shape that facilitates sealing and enhances the seal formed by seat 416. As described in more detail with reference to detail 10 shown in FIG. 5 and illustrated in FIG. 10, as arcuate disc 104 is rotated within seat ring 402, opposite sides of the seat ring 402 form unbalanced hydrostatic loads that assist the seat ring 402 to form a seal at seat 416. Because both sides of seat ring 402 form an upstream hydrostatic surface area that is greater than a downstream hydrostatic surface area, pressurized fluid in the valve channel 506 increases the hydrostatic load on the sealing side of seat ring 402 regardless of the orientation of disc 104 relative to seat ring 402.

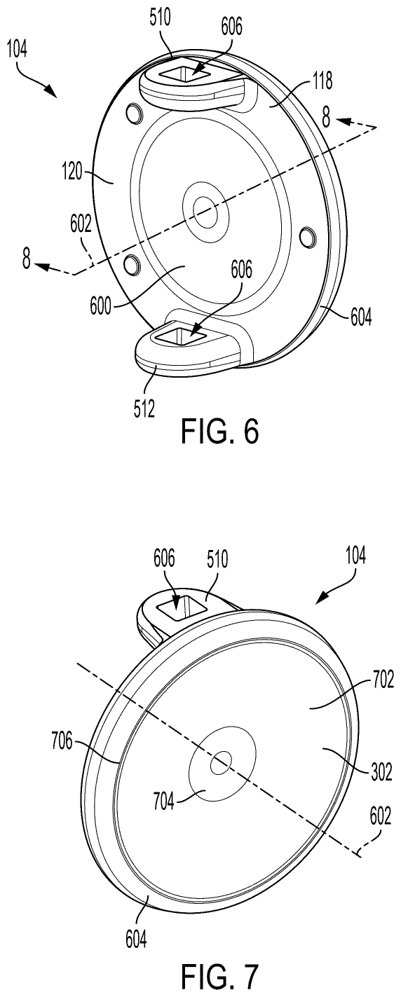

FIG. 6 shows arcuate back surface 120 of disc 104. Flat base section 118 circumferentially surrounds the perimeter of a convex surface 600 extending inwards at a central axis 602 of disc 104. Arcuate disc 104 can extend inwards of the flow or valve channel 506, e.g., towards a location where stem 114 would extend behind disc 104. For example, arcuate disc 104 can extend into valve channel 506 of valve 100. The circumferential base section 118 supports convex arcuate back surface 120 and facilitates the formation of a lip 604 that facilitates the formation of a fluid-tight seal at seat 416 between arcuate disc 104 and seat ring 402.

Upper ear 510 and lower ear 512 are shown with a rectangular hole 606 and can be configured to couple upper ear 510 with stem 114 and lower ear 512 with lower stem 114. Because stem 114 and rectangular holes 606 can have a non-circular perimeter, stem 114 can effectively rotate the disc 104 (e.g., at upper ear 510) without slippage. In various aspects, the fit can be oriented relative to the open configuration 106 and/or the closed configuration 300. Similarly, in some aspects, the fit can be a friction fit. In other aspects, the fit can include an orientation fit that facilitates assembly, disassembly, and/or servicing of valve 100 with hand tools.

FIG. 7 shows the concave arcuate front surface 302 of disc 104. Upper ear 510, comprising rectangular hole 606, can be seen extending from arcuate back surface 120 (FIG. 6), and lip 604. A radial surface 702 extends from a central cup 704 to lip 604, and the intersection of central cup 704 and lip 604 defines an outer circumference 706 of concave arcuate front surface 302. That is, central cup 704 defines an inner circumference of concave arcuate front surface 302 that extends from central cup 704 adjacent to central axis 602 of disc 104 to the outer circumference 706.

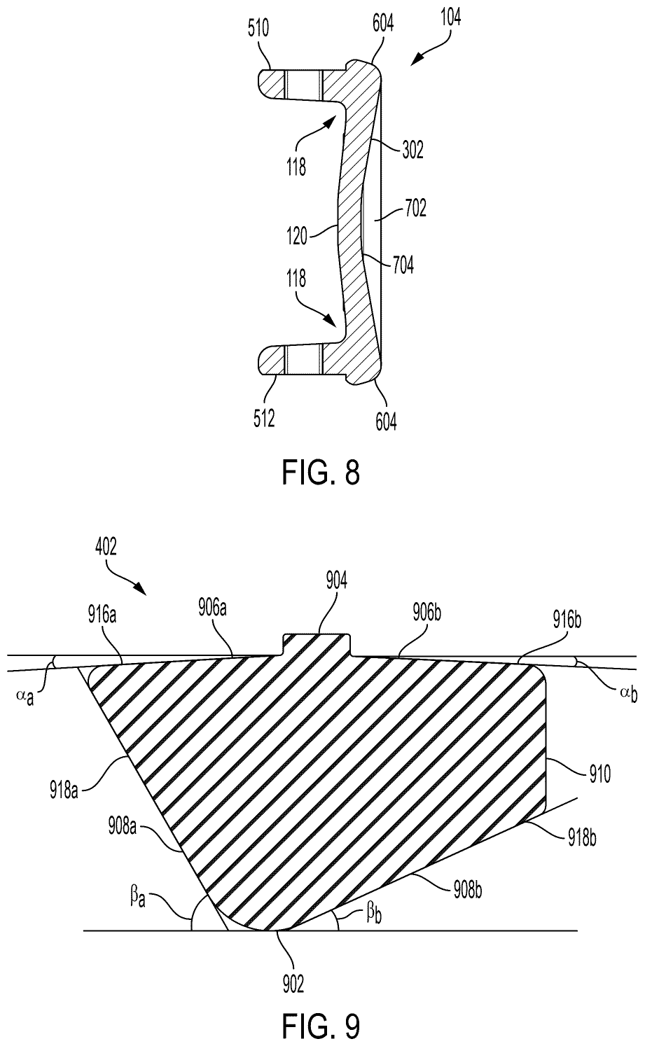

FIG. 8 is a cross-section of disc 104 shown in FIGS. 6 and 7. Upper ear 510 and lower ear 512 each comprise the rectangular holes 606 on either side of arcuate back surface 120 that is shown in a convex orientation, extending along central axis 602. Similarly, central axis 602 shows that arcuate front surface 302 also extends in a concave orientation, such that a central area of from surface 302 extends inward from the lip 604 and arcuate front surface 302 creates an enlarged cross-sectional area within valve 100. That is, on the convex arcuate back surface 120, the cross-sectional area within valve 100 is reduced and creates a higher velocity in the fluid. On the concave arcuate front surface 302, the cross-sectional area within valve 100 is increased, reducing the pressure on this side of disc 104.

Lip 604 is shown with radial surface 702 that interacts with seat ring 402 to form a fluid tight seal in the seat 416 of valve body 110.

FIG. 9 shows a cross-section of seat ring 402 of detail 10 in isolation. As described above, seat ring 402 can be used with a flat disc 104. Similarly, a dished disc 104 can be used with the seat ring 402 to create a cross-sectional area within valve 100 in the open configuration 106. Seat ring 402 facilitates a large directional surface area to be exposed to hydrostatic loading regardless of the direction of fluid flow through valve channel 506. Seat ring 402 comprises a sealing lip 902 located on a radially inward portion of seat ring 402, e.g., the radially inward portion of the annular seat ring 402 relative to axis 514 (FIG. 5). A rib 904 is disposed opposite sealing lip 902, e.g., on a radially outward portion of the seat ring 402 relative to axis 514 (FIG. 5). Rib 904 can have a rectangular cross-section to facilitate compressing the rib between the valve body 110 and the endcap 112.

Rib 904 forms a rectangular projection that can be captured between the valve body 110 and the endcap 112 (FIG. 1). When valve body 110 is coupled to endcap 112, rib 904 is captured between the valve body 110 and endcap 112 in a rib groove 1016 to seal and/or close valve 100. Rib 904 defines a pair of opposed shoulders 906a,b, and sealing lip 902 is formed at the intersection of a pair of opposed angular portions 908a,b. In some aspects, seat ring 402 comprises rib 904 captured between valve body 110 and endcap 112 and divides seat ring 402 into a pair of opposed shoulders 906a,b extending into the valve body 110 and endcap 112, respectively. For example, shoulder 906a can extend from rib into valve body 110, and shoulder 906b can extend from rib 904 into endcap 112. In other aspects, shoulder 906a can extend into endcap 112, and shoulder 906b can extend into valve body 110. As illustrated in FIGS. 9-10, the shoulders 906a,b can form a respective angle “alpha” αa,b relative to axis 602 (FIG. 6), and/or angular portions 908a,b can form a respective angle “beta” βa.b relative to axis 602. For example, shoulder 906a can form an angle αa, and angular portion 908a can form an angle βa. Similarly, shoulder 906b can form an angle αb, and angular portion 908b can form an angle βb.

Angles α and/or β can increase the ability of a fluid to increase the hydrostatic pressure on rib 904 and create a hydrostatic gap (e.g., gap 1004, as illustrated in FIG. 10). As shown, shoulders 906a,b define corresponding frustoconical surfaces 916a,b, and angled surfaces 908a,b, similarly define corresponding frustoconical surfaces 918a,b that fit within gap 1004 (FIG. 10) defined between valve body 110 (e.g., body groove 1012) and endcap 112 (e.g., endcap groove 1014).

Opposed angular portions 908a,b can extend to sealing lip 902. That is, angular portion 908a can extend from shoulder 906a to sealing lip 902 and/or angular portion 908b can extend from sealing lip 902 to a flat surface 910 coupled to shoulder 906b. Sealing lip 902 can be defined at the intersection of opposed angular portions 908a,b. For example, angular portion 908a can be a valve body angled portion that extends from the valve body shoulder (e.g., shoulder 906a) to the sealing lip 902 and angular portion 908b can be an endcap angled portion that extends from the endcap shoulder (e.g., shoulder 906b) to the sealing lip 902. In various aspects, the angular portion 908b can be the valve body angled portion, and the angular portion 908a can be the endcap angled portion.

Angular portions 908a,b are oriented relative to axis 514 (FIG. 5) to create a larger net directional surface area in the flow that exposes the seat ring 402 to the hydrostatic pressure of the working fluid. The increased net surface area results in greater hydrostatic forces being generated on the upstream angular portion (e.g., 908a) than the downstream angular portion 908b, with a surface area compressed against one of the valve body 110 or the endcap 112. The angular portion 908a,b generates unbalanced hydrostatic loads that assist in the formation of a seal within seat 416 due to the hydrostatic gap on an upstream end and the compressive force generated on the downstream end of seat ring 402. The hydrostatic seal can be formed regardless of the direction of fluid flow within valve channel 506. Shoulders 906a,b can form angles α (FIG. 10), and/or angular portions 908a,b can form angle β (FIG. 10) relative to axis 602 of the valve body. Hydrostatic pressure created by a working fluid (e.g., water) can compress angles α and/or β and can increase the hydrostatic pressure on rib 904. The increased hydrostatic pressure can create a hydrostatic gap (e.g. gap 1004, as illustrated in FIG. 10) that compresses the seat ring 402 and forms a seal that varies depending on the hydrostatic pressure to form a seal.

FIG. 10 shows an enlarged view of detail 10 of seat ring 402, shown in FIG. 5. Valve body 110 is coupled to endcap 112 to capture rib 904 of seat ring 402, and, in some aspects, an O-ring 1002 is captured in a groove formed between the endcap 112 and the valve body 110. Seat ring 402 further comprises angular portions 908a,b that can be compressed (e.g., by hydrostatic loads generated in the working fluid). For example, shoulders 906a,b, and/or angular portions 908a,b can form gaps 1004 within seat 416.

For example, a parallel portion 1008 of valve body 110 and/or a parallel portion 1010 of endcap 112 can be adjacent to shoulder 906a and/or 906b, respectively. Parallel portion 1008 of valve body 110 and/or parallel portion 1010 can be parallel and cylindrical relative to axis 608 (FIG. 6) and thereby create gaps 1004 with angles α relative to seat ring 402. Further, a body groove 1012 in valve body 110 and/or an endcap groove 1014 can accept the seat ring 402 and define parallel portion 1008 and/or parallel portion 1010, respectively. In various aspects, seat ring 402 can be entirely captured by the rib groove 1016 defined by either valve body 110 and/or endcap 112. In the current aspect, the rib groove 1016 is defined by the valve body 110. In some aspects, as shown, a portion of seat ring 402, such as rib 904, can be captured within or between the body groove 1012 and the endcap groove 1014.

In various aspects, gaps 1004 can form hydrostatic gaps 1004, for example, when seat ring 402 experiences hydrostatic pressure. Seat ring 402 can use the hydrostatic pressure to load the seat ring 402 and form a seal when sealing lip 902 interacts with lip 704 of disc 104. For example, gap 1004 can be formed in seat 416. For example, when disc 302 is in the close configuration, the hydrostatic load can develop on one side. For example, a hydrostatic load is shown developed on shoulder 906b and angular portion 908b to create a gap 1004. The hydrostatic load can push the angular portion 908b away from endcap groove 1014 to all fluid to flow into hydrostatic gap 1004. Hydrostatic gaps 1004 can form and/or grow on either side of the rib 1004 between shoulders 906a,b, and parallel portions 1008, 1010, respectively. Because of the angle α of shoulders 906a,b, the gap 1004 can form on the upstream side of shoulder 906a (or on the downstream side of shoulder 906b) regardless of the flow direction of the working fluid within valve channel 506.

In some aspects, bearings 1006 can facilitate rotation of stem 114 supporting arcuate disc 104. Similarly, concave arcuate front surface 302 is shown interfacing with the hydrostatic load in the fluid channel (e.g., valve channel 506), but in some aspects, the convex arcuate back surface 120 can interface with the hydrostatic load in the fluid channel.

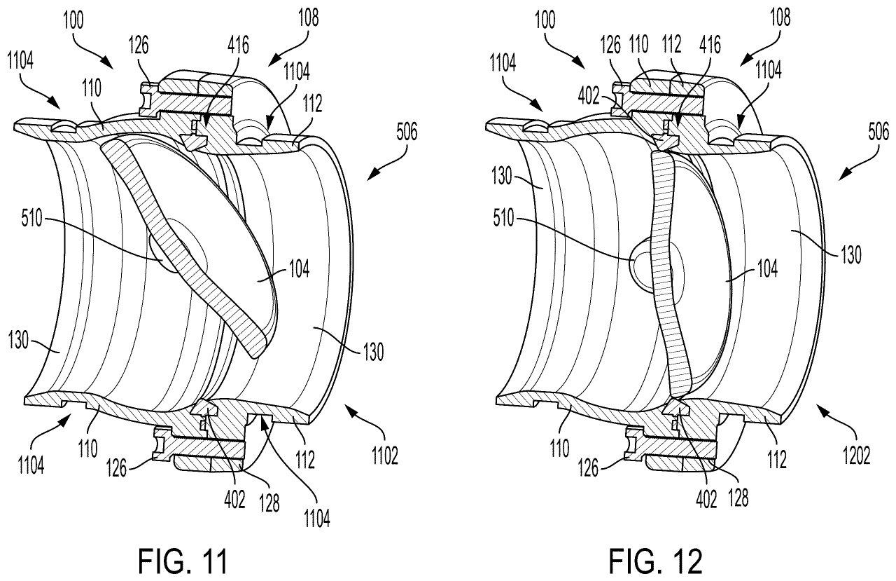

FIG. 11 is a cross-sectional view of valve 100 operating with disc 104 in a partially open configuration 1102, and FIG. 12 is a cross-sectional view of valve 100 operating with disc 104 in a nearly closed configuration 1202. Seat 416 is shown with offset 1606 (FIG. 16), and seat ring 402 can move and/or swell when disc 104 encounters seat ring 402. With reference to FIGS. 11 and 12, valve 100 is shown moving from the partially open configuration 1102 (e.g., greater than approximately 5%) to the partially closed or nearly closed configuration 1202 (e.g., less than approximately 5%). As shown, offset 1606 (FIG. 16) can enhance the flow dynamics through valve 100 because offset 1606 minimizes the interaction between disc 104 and seat 416. For example, if disc 104 comprises metal and seat 416 comprises rubber, the rubber in seat 416 can cause swelling when in contact with a working or process fluid. One example of a working fluid known to cause swelling in a rubber seat is antifreeze, which can, through exposure, cause rubber to swell.

Seat 416 swelling can make operation (e.g., either by hand-operated actuation of handle 102 or an automated actuator coupled to stem 114 and/or handle 102) of valve 100 difficult. The rubber swelling in seat 416 increases the friction required to turn disc 104 and can prevent rotation (e.g., from open configuration 106 in FIG. 1 to closed configuration 300 in FIG. 3 and vice versa) and/or prevent the formation of a proper seal at seat 416 in the closed configuration 300. Ridges 1104 in valve body 110 and/or endcap 112 can be formed to facilitate coupling valve 100 to a pipe with a pipe coupling or other hardware. For example, a pipe coupling can be inserted into ridge 1102, and a gasket extended over the end of the pipe and endcap 112 to create a sealed junction illustrated in FIGS. 11-14. In other aspects, pipes and other couplings can be used to create a joint with valve 100.

Offset 1606 (FIG. 16) can reduce the interaction between disc 104 and seat 416 and can cause disc 104 to only encounter seat ring 402 when seating, (e.g., nearly closed configuration 1202). In this configuration, only a small percentage of the travel of disc 104 interacts with the rubber of seat 416 and the friction in the valve 100 is reduced.

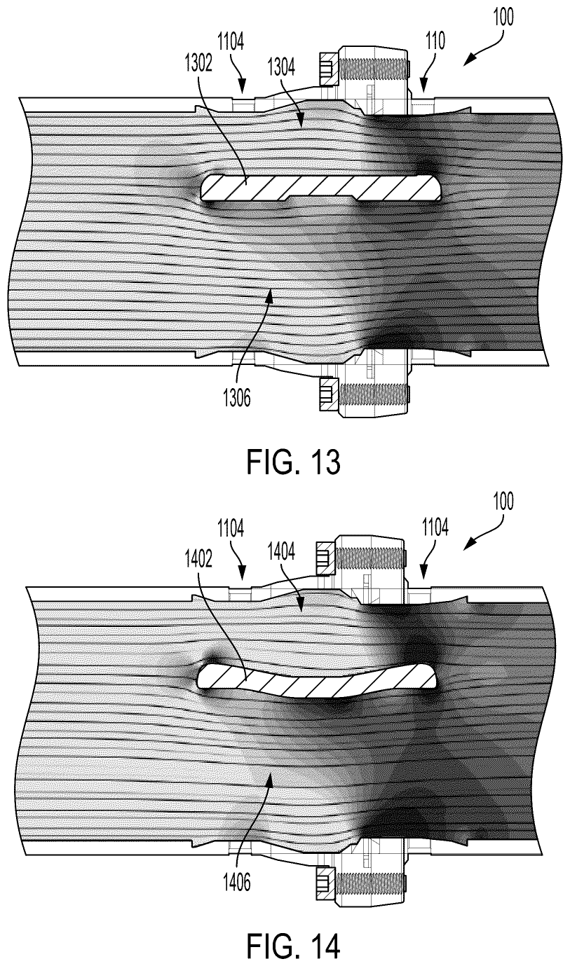

FIGS. 13 and 14 compare cross-sectional schematics to illustrate variations in the fluid dynamics of fluid flowing through butterfly valves 100 with a flat disc 1302 shown in FIG. 13, and an arcuate disc 1402 shown in FIG. 14. In some aspects, arcuate disc 1402 can be the same as, or similar to, disc 104 described above. Grooves and/or ridges 1104 in the outer surfaces can be used with pipe fittings, e.g., to couple the valve 100 to a pipe. Other configurations for joining pipes are also contemplated.

FIG. 13 shows exemplary fluid dynamics where the pressure and velocity in an upper channel 1304 and lower channel 1306 are approximately equal due to the linear nature of flat disc 1302, and equal pressure is created on opposite sides of the flat disc 1302. In contrast, the annular disc 1402 shows a pressure/velocity differential created by the channels created by the annular disc 1402. For example, a low-pressure and high-velocity upper channel 1404 can be generated when butterfly valve 100 comprises a concavely shaped arcuate disc 1402 that increases the pressure and/or reduces the velocity of fluid traversing through the upper channel 1404. Similarly, the arcuate disc 1402 can create a differential between the upper channel 1404 and a high-pressure and low-velocity lower channel 1406 by reducing the pressure and/or increasing the velocity through the lower channel 1406 relative to the upper channel 1404.

The differential can comprise a comparison of a butterfly valve with a flat disc 1302 and an arcuate disc 1402. That is, the velocity in the upper channel 1404 of a valve with the arcuate disc 1402 can be less than the velocity in the upper channel 1304 (FIG. 13) of a valve with a flat disc 1302. Similarly, the velocity in the lower channel 1406 of the butterfly valve 100 comprising the annular disc 1402 is greater than the velocity in the in the lower channel 1306 (FIG. 13) with the flat disc 1302 (FIG. 13).

The pressure differential between the upper channel 1404 and the lower channel 1406 effectively balances the areas to balance the flow through the butterfly valve 100. When the fluid flows over the arcuate disc 1402 on the lower channel 1406, the relative larger size of the lower channel 1406 may slightly increase the pressure, but the fluid recovers any losses quickly downstream, in part because this loss can be minimized by the larger area of the lower channel 1406. Similarly, on the upper channel 1404, the inward turn of fluid increases the fluid flow and the faster flow (e.g., higher velocity) through the upper channel 1404 increases the flow through the upper channel and lowers the pressure on the more restricted side of arcuate disc 1402. Due to this pressure/velocity differential across the arcuate disc 1402, the total volume of fluid that is able to pass through the valve is increased, and the butterfly valve 100 can accommodate more fluid flow because the fluid recovers downstream, away from the butterfly valve 100. The equalizing factor can be controlled by slightly increasing the pressure in the lower channel 1406, but does not create a downstream restriction and reduces the overall pressure loss through the butterfly valve 100.

Similarly, within the butterfly valve 100 comprising an arcuate disc 1402, the velocity in the upper channel 1404 can be greater than the velocity in the lower channel 1406 of the butterfly valve 100 with the arcuate disc 1402. However, when the butterfly valve 100 is in the open configuration 106 (FIG. 1) the pressure and/or velocity differential created by annular disc 1402 facilitates the transport of fluid through the butterfly valve 100. Annular disc 1402 creates opposing fluid dynamic properties in upper channel 1404 and lower channel 1406 that offset one another and increase the flow capacity coefficient Cy through the valve. That is, a greater volume (e.g., gallons) of the working fluid, such as water, is able to pass through the butterfly valve 100 comprising the annular disc 1402 than can pass through the otherwise same butterfly valve comprising the flat disc 1302. Stated differently, more fluid can pass through the butterfly valve 100 comprising the annular disc 1402 incurring a loss of 1 psi in the working fluid than can pass through an otherwise similar butterfly valve 100 comprising the flat disc 1302.

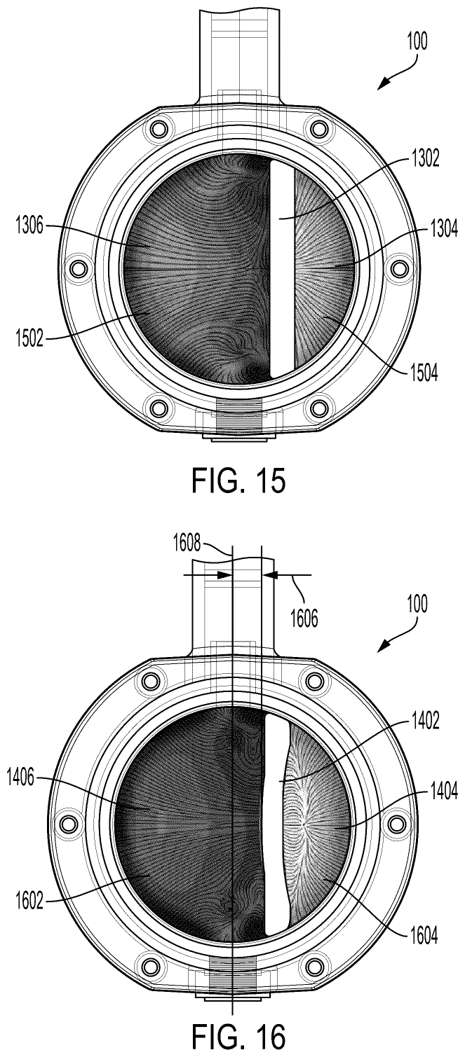

FIGS. 15 and 16 compare front-view schematics of the fluid dynamics similar to FIGS. 13 and 14 to compare the fluid dynamics through butterfly valves 100 with a flat disc 1302 compared to arcuate disc 1402. In FIG. 15, the flat disc 1302 shows a pressure differential between a left channel 1502 and a right channel 1504, where “left” and “right” are relative to the illustrated view shown. The dynamics within the left channel 1502 and right channel 1504 remain relatively consistent throughout where the flat disc 1302 is used. The left channel 1502 can have a pressure and/or velocity that is relatively similar to the right channel 1504, though some changes can result from the relative sizes of the right channel 1504 relative to the left channel 1502.

With respect to FIG. 16, the convex arcuate back surface 120 (e.g., outer arcuate side) of arcuate disc 1402 can reduce the cross-sectional area of the left channel 1602 and may slightly increase the pressure and/or decrease the velocity of the fluid traversing through the left channel 1602 of the butterfly valve 100. The convex arcuate back surface 120 of arcuate disc 1402 can increase the pressure of the fluid traversing through the left channel 1602 relative to the left channel 1502 created with the flat disc 1302. Similarly, a right channel 1604 can decrease the pressure and/or increase the velocity traversing through the right channel 1604 with the arcuate disc 1402 relative to an otherwise similar butterfly valve 100 comprising a flat disc 1302.

The arcuate disc 1402 (e.g., comprising the convex arcuate back surface 120 and/or concave arcuate front surface 302, shown in FIG. 3) can create an inversely proportional relationship, e.g., pressure/velocity differential, between the pressure and/or velocity in the left channel 1602 relative to the pressure and/or velocity in the right channel 1604. For example, as a result of the decreased pressure in the right channel 1604, the speed or velocity of the fluid traversing through the right channel 1604 of the valve 100 is increased, resulting in a more balanced fluid flow through the left and right channels 1602 and 1604. Similarly, the higher pressure through the right channel with arcuate disc 1402 reduces the velocity and the amount of fluid flowing through the channel. Due to the pressure and velocity differential across the arcuate disc 1402, the butterfly valve 100 can accommodate more fluid through the valve for the same pressure loss (e.g., 1 psi). Thus, the arcuate disc 1402 increases the volume of fluid that passes through the butterfly valve 100 with the pressure and velocity differential, relative to a similar butterfly valve 100 comprising the flat disc 1302. Thus, the flow capacity coefficient Cᵥ is increased and enhanced through the butterfly valve 100 with an annular disc 1402 comprising a convex surface (e.g., arcuate back surface 120) opposite a concave surface (e.g., arcuate front surface 302).

As seen in FIG. 16, the arcuate disc 1402 is further enhanced by an offset 1606 from a valve centerline 1608 defined by stem 114. The convex arcuate back surface 120 compresses the larger left channel 1602 to reduce the impact of the increased pressure generated by the arcuate back surface 120 in the larger left channel 1602. Similarly, the concave arcuate front surface 302 expands the cross-sectional area of the smaller right channel 1604 to decrease the pressure and/or increase the fluid velocity through the right channel 1604 and create the pressure/velocity differential. Similarly, the velocity in the right channel 1404 can be increased to balance the fluid traversing through the butterfly valve 100. In this way, the offset 1606 of annular disc 104 can provide a larger cross-sectional area, with arcuate disc 1402 to increase pressure in the left channel 1602. In other aspects, the annular disc 1402 can be rotated in the opposite direction and/or the arcuate front surface 302 can be convex and/or the arcuate back surface 120 can be concave.

With respect to FIGS. 1-16, in various aspects, in open configuration 106 (FIG. 1) valve 100 can comprise disc 104 of valve body 110. For example, in the open configuration 106, a first surface (e.g., arcuate front surface 302) of the disc 104 is closer to sidewall 130 of valve-body assembly 108 (e.g., valve body 110 and/or endcap 112) than a second surface (e.g., arcuate back surface 120) of the disc 104. Arcuate front surface 302 can restrict a working fluid and/or flow through at disc 104 of valve 100 at centerline 1608.

In some aspects arcuate front surface 302 of disc 104 defines offset 1606 relative to centerline 1608 of valve-body assembly 108 and a ratio of the disc 104 diameter to the offset 1606 is greater than 5%. In various aspects, the disc 104 can further comprise first and second ears disposed on the arcuate back surface 120.

When disc 104 is in the open configuration 106, the disc 104 can divide a flow channel of the valve channel 506 into a first channel and a second channel (e.g., left channel 1602 and/or right channel 1604 of FIG. 16). That is, the first channel can be adjacent to the arcuate front surface 302 and the second channel can be adjacent to the arcuate back surface 120. In various aspects, illustrated in FIGS. 15-16, the first channel (e.g., channel 1602 in FIG. 16) has a greater cross-sectional area than the second channel (e.g., channel 1604 in FIG. 16). For example, an average velocity of the fluid in the first channel can be less than an average velocity of fluid in the second channel. Similarly, the relationship can be inversely proportional such that the average pressure of the fluid in the first channel can be greater than the average pressure of the fluid in the second channel to increase the velocity in the second channel and create a differential pressure and/or velocity balance through butterfly valve 100.

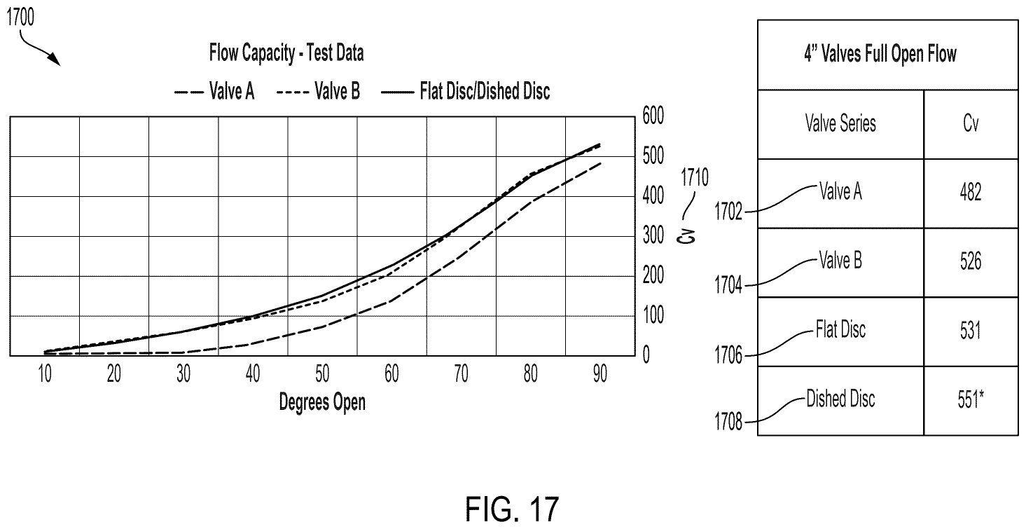

FIG. 17 is a schematic flow diagram 1700 illustrating the improved flow capacity Cᵥ that results from using an arcuate disc at various orientations within a 4-inch valve 100. Specifically, diagram 1700 shows four different valve configurations: valve A 1702, valve B 1704, flat disc 1706 (the same as or similar to disc 1302), and dished disc 1708 (the same as or similar to curved, or dished discs previously shown, e.g., disc 104, arcuate disc 1402), each plotted against a flow capacity variable Cᵥ 1710. Valve A 1702 and Valve B 1704 are benchmark valves that do not comprise an arcuate or dished structure. Flat disc 1706 and dished disc 1708 are the same valve 100 (e.g., have the same valve-body assembly 108) but comprise different discs 104. That is, the only difference between the valves is one has a flat disc 1706 and the other has a dished disc 1708. As shown, when each valve is fully open (e.g., oriented at 90°), the dished disc 1708 has the largest measured flow capacity variable Cᵥ 1710 value equal to or greater than 551. In some aspects, the flow capacity variable Cᵥ 1710 of valve 100 comprising a dished disc can exceed 531, and specifically 535, and more specifically 540. In other words, holding all other variables constant, changing the flat disc 1706 to a dished disc 1708 has been shown experimentally to enhance the flow capacity variable Cᵥ 1710 in a fully open configuration 106.

At the other end, in a nearly closed configuration 1202, the curvilinear plots of flow capacity variable Cᵥ 1710 to the 10° degree-open case, all converge at zero. That is, offset 1606 (FIG. 16) results in a reduced friction joint that has not comprised efficiency in the closed configuration 300.

The description is provided as an enabling teaching of the present devices, systems, and/or methods in their best, currently known aspect. To this end, those skilled in the relevant art will recognize and appreciate that many changes can be made to the various aspects described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an” and “the” include plural referents unless the context clearly dictates otherwise. Thus, for example, reference to a quantity of one of a particular element can comprise two or more such elements unless the context indicates otherwise. In addition, any of the elements described herein can be a first such element, a second such element, and so forth (e.g., a first widget and a second widget, even if only a “widget” is referenced).

Ranges can be expressed herein as from “about” one particular value, and/or to “about” another particular value. When such a range is expressed, another aspect comprises from the one particular value and/or to the other particular value. Similarly, when values are expressed as approximations, by use of the antecedent “about” or “substantially,” it will be understood that the particular value forms another aspect. It will be further understood that the endpoints of each of the ranges are significant both in relation to the other endpoint, and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance may or may not occur, and that the description comprises instances where said event or circumstance occurs and instances where it does not.

The word “or” as used herein means any one member of a particular list and also comprises any combination of members of that list. The phrase “at least one of A and B” as used herein means “only A, only B, or both A and B”; while the phrase “one of A and B” means “A or B.”

As used herein, unless the context clearly dictates otherwise, the term “monolithic” in the description of a component means that the component is formed as a singular component that constitutes a single material without joints or seams.

To simplify the description of various elements disclosed herein, the conventions of “left,” “right,” “front,” “rear,” “top,” “bottom,” “upper,” “lower,” “inside,” “outside,” “inboard,” “outboard,” “horizontal,” and/or “vertical” may be referenced. Unless stated otherwise, “front” describes that end of the seat nearest to and occupied by a user of a seat; “rear” is that end of the seat that is opposite or distal the front; “left” is that which is to the left of or facing left from a person sitting in the seat and facing towards the front; and “right” is that which is to the right of or facing right from that same person while sitting in the seat and facing towards the front. “Horizontal” or “horizontal orientation” describes that which is in a plane extending from left to right and aligned with the horizon. “Vertical” or “vertical orientation” describes that which is in a plane that is angled at 90 degrees to the horizontal.

One should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily comprise logic for deciding, with or without user input or prompting, whether these features, elements and/or steps are included or are to be performed in any particular aspect.

It should be emphasized that the above-described aspects are merely possible examples of implementations, merely set forth for a clear understanding of the principles of the present disclosure. Many variations and modifications may be made to the above-described aspect(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. A disc valve comprising:
a valve body;
a disc positioned in the valve body, the disc rotatable within the valve body to define an open configuration and a closed configuration, the disc comprising:
an arcuate convex first surface; and
an arcuate concave second surface; wherein the first surface is opposed to the second surface.

2. The disc valve of claim 1, wherein when the disc is in the open configuration of the valve body the first surface is closer to a sidewall of the valve body than the second surface.

3. The disc valve of claim 1, wherein the disc valve further defines a centerline and wherein the first surface restricts a fluid flow through the disc valve at the centerline.

4. The disc valve of claim 1, wherein the disc valve further comprises a stem and a stub coupled to the disc such that neither the stem nor the stub enter a flow channel of the disc valve.

5. The disc valve of claim 1, further comprising a seat ring between a valve body and an endcap.

6. The disc valve of claim 1, wherein the disc further comprises a first ear and a second ear disposed on the second surface.

7. The disc valve of claim 1, further comprising a stem coupled to a first ear of the disc and a stub coupled to a second ear of the disc opposite the stem.

8. The disc valve of claim 7, wherein an offset in the first surface extends into a centerline of the valve body extending between the stem and the stub.

9. The disc valve of claim 1, wherein when the disc is in an open configuration, the disc divides a flow channel into a first channel adjacent the first surface and a second channel adjacent the second surface, and wherein the first channel has a greater cross-sectional area than the second channel.

10. The disc valve of claim 9, wherein:
an average velocity of fluid in the first channel is greater than an average velocity of fluid in the second channel; and
an average pressure of fluid in the first channel is less than an average pressure of fluid in the second channel.

11. A disc valve comprising:
a valve body;
an endcap coupled to the valve body;
a seat ring comprising:
a rib captured between the valve body and the endcap;
a valve body shoulder extending from the rib towards the valve body;
an endcap shoulder extending from the rib towards the endcap;
a valve body angled portion extending from the valve body shoulder;
an endcap angled portion extending from the endcap shoulder; and
a sealing lip defined at the intersection of the valve body angled portion and the endcap angled portion.

12. The disc valve of claim 11, wherein a hydrostatic gap extends between the seat ring and the endcap.

13. The disc valve of claim 11, wherein a hydrostatic gap extends between the seat ring and the valve body.

14. The disc valve of claim 11, wherein the seat ring comprises an axis extending through the endcap and the valve body and wherein:
the rib is positioned radially outward of the sealing lip relative to the axis;
the rib is compressed between the valve body and the endcap; and
in a closed configuration, at least one angular portion defines a hydrostatic gap.

15. The disc valve of claim 11, wherein the valve body shoulder is positioned within the valve body and the endcap shoulder is positioned within the endcap.

16. The disc valve of claim 11, wherein the seat ring defines a circumferential area extending across a seat in a closed configuration, and wherein the circumferential area across the seat on an upstream side of the seat is greater on than the area on a downstream side of the seat.

17. The disc valve of claim 11, wherein the valve body shoulder and the endcap shoulder are angled relative to an axis extending through a channel of the endcap and the valve body.

18. The disc valve of claim 11, wherein the valve body comprises a body groove comprising a parallel portion of the valve body that is parallel to the axis, and the endcap comprises an endcap groove comprising a parallel portion of the endcap that is parallel to the axis.

19. The disc valve of claim 11, wherein the sealing lip forms a curved surface that interacts with a butterfly disc in the valve body.

20. The disc valve of claim 19, wherein the butterfly disc comprises an arcuate convex first surface opposite an arcuate concave second surface.
